(19) United States
(12) Patent Application Publication
(10) Pub. No.: US 2025/0023215 A1
(43) Pub. Date: Jan. 16, 2025

(54) ENHANCED ELECTROLYTE INFILTRATION IN A BATTERY CELL

(71) Applicant: Techtronic Cordless GP, Anderson, SC (US)

(72) Inventors: Dan GENG, Guangdong (CN); Denis FAUTEUX, Hong Kong (CN); Jin Wei LI, Guangdong (CN)

(21) Appl. No.: 18/714,450

(22) PCT Filed: Dec. 2, 2021
(86) PCT No.: PCT/CN2021/135186

§ 371 Date: May 29, 2024

(51) Int. Cl. H01M 50/627; H01M 10/04

(52) U.S. Cl. CPC H01M 50/627; H01M 10/0422; H01M 10/0431; H01M 10/049

(57) ABSTRACT

A cylindrical battery cell. The cylindrical battery cell includes an anode, a cathode, one or more separator sheets that separates the anode from the cathode, an electrolyte and a cylindrical housing. The anode, the one or more separator sheets, and the cathode are rolled together to form a roll and the anode, the cathode and the one or more separators form concentric layers within the roll. The roll is seated in the cylindrical housing. At least one of the anode and the cathode includes a plurality of apertures formed from an inner radial surface of the roll to an outer radial surface of the roll. The plurality of apertures form passageways that are configured to facilitate a flow of the electrolyte within the roll such that the electrolyte flows into the roll.

### FIELD

The present application relates generally to batteries, and in particular, to specific battery cell configurations to enhance electrolyte infiltration in a battery cell.

### BACKGROUND

Batteries are critical in providing power to many electrical devices that are relied upon daily. Cylindrical batteries with a rolled arrangement are commonly used to power electrical devices. These battery types are often referred to as “jelly-roll” batteries. A rolled cylindrical battery generally includes an anode and a cathode separated by one or more separator sheets. The anode, separator, and cathode are rolled cylindrically together with small gaps between concentric layers of the roll and placed into a battery housing with electrical terminals provided at either end of the housing. In tables jelly roll battery cells, a conductive strip generally runs the length of the cathode and/or the anode. The conductive strip of each concentric layer of the roll may be rubbed (or otherwise formed) together with the other conductive strips of each concentric layer of the jelly roll at a rubbing region such that they are able to form a connection point to effectively electrically connect to the electrical terminal of the battery housing.

Additionally, jelly roll battery cells require an electrolyte to provide ion transportation between the anode and the cathode. The electrolyte is generally a liquid that flows between the concentric layers of a rolled battery cell. Prior to the present invention, it is difficult for the electrolyte to infiltrate the layers of the roll when the conductive strips are rubbed together (such as in a tables jelly-roll battery cell), as the electrolyte is often introduced into the battery cell via an opening at the top of the battery housing after the jelly roll is inserted. Even under high pressure, insufficient infiltration of the electrolyte occurs, decreasing the performance of the battery (e.g., decreased capacity and/or cycle performance). Thus, there is a need for jelly roll battery cell configurations to improve electrolyte infiltration within rolled battery cells.

### SUMMARY

The battery cells described herein include configurations to improve infiltration of an electrolyte within a rolled battery cell. For example, the included configurations may provide passageways at the rubbing region of the electrode sheets to allow the electrolyte to efficiently and fully infiltrate the layers of the rolled battery cell. For example, passageways may be provided in a radial direction and/or a longitudinal direction to allow for maximum electrolyte infiltration.

Embodiments described herein provide a cylindrical battery cell. The cylindrical battery cell includes an anode, a cathode, one or more separator sheets that separates the anode from the cathode, an electrolyte, and a cylindrical housing. The anode, the one or more separator sheets, and the cathode are rolled together to form a roll and the anode, the cathode and the one or more separators form concentric layers within the roll. The roll is seated in the cylindrical housing. At least one of the anode and the cathode includes a plurality of apertures formed from an inner radial surface of the roll to an outer radial surface of the roll. The plurality of apertures form passageways that are configured to facilitate a flow of the electrolyte within the roll.

Other embodiments described herein provide a method of infiltrating an electrolyte in a cylindrical battery cell. The method comprises rolling an anode, one or more separator sheets, and a cathode about a central axis to form a roll with concentric layers, rubbing a portion of at least one of the anode and the cathode together to create a rubbing region with a flat top surface, forming a plurality of apertures at the rubbing region of at least one of the anode and the cathode, the plurality of apertures being provided radially from the center of the roll to an outer surface of the roll to form one or more passageways, inserting the roll in a cylindrical battery housing, and introducing an electrolyte at least one of radially into at least one of the plurality of apertures and longitudinally through a center of the roll.

Other embodiments described herein provide a tables battery cell. The tables battery cell includes an anode, a cathode, one or more separator sheets that separates the anode from the cathode, and an electrolyte. The anode, the one or more separator sheets, and the cathode are rolled together to form a roll and form concentric layers within the roll. A portion of one of the anode or the cathode is rubbed together to create a rubbing region with a flat top surface. At least one of the anode and the cathode includes a plurality of apertures forming one or more passageways. The one or more passageways are configured to be filled with the electrolyte and the electrolyte flows downwards into the roll.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a battery cell, in accordance with some embodiments.

FIG. 2 illustrates a battery cell assembly, in accordance with some embodiments.

FIGS. 3A & 3B illustrate electrode sheets, in accordance with some embodiments.

FIG. 4 illustrates a rolled electrode assembly, in accordance with some embodiments.

FIG. 5 illustrates a planar view of a battery cell, in accordance with some embodiments.

FIG. 6 illustrates electrolyte infiltration paths for the battery cell of FIG. 5, in accordance with some embodiments.

FIG. 7 is a block diagram illustrating a method of an electrolyte infiltrating a rolled electrode assembly, in accordance with some embodiments.

FIG. 8 is a block diagram illustrating a method of an electrolyte infiltrating a rolled electrode assembly, in accordance with some embodiments.

### DETAILED DESCRIPTION

An anode, a separator sheet, and a cathode are rolled together to form a rolled cell with concentric layers. An electrode portion of the anode and/or cathode is rubbed with the corresponding electrode portions of the concentric layers to form a rubbing region. In order to maximize electrolyte infiltration in the layers of the roll, passageways are provided at the rubbing region.

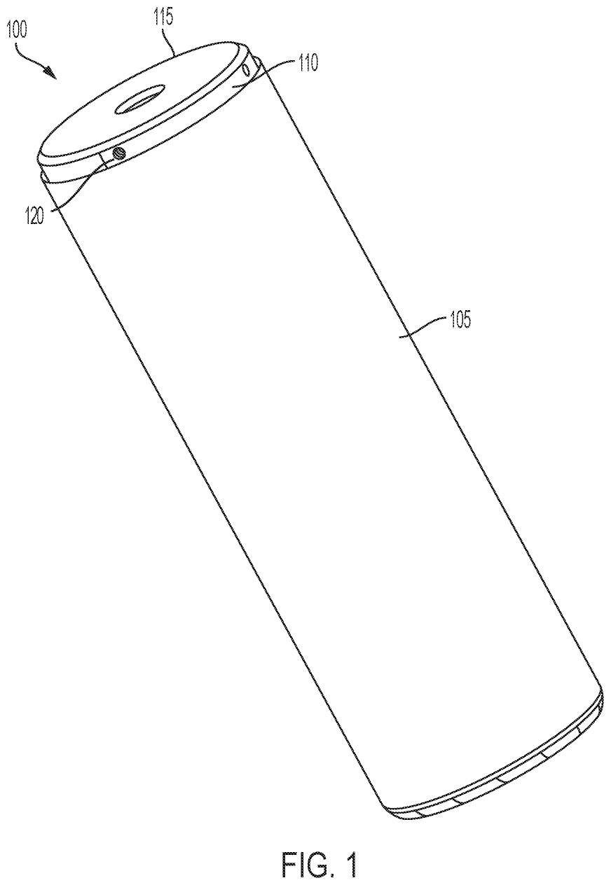

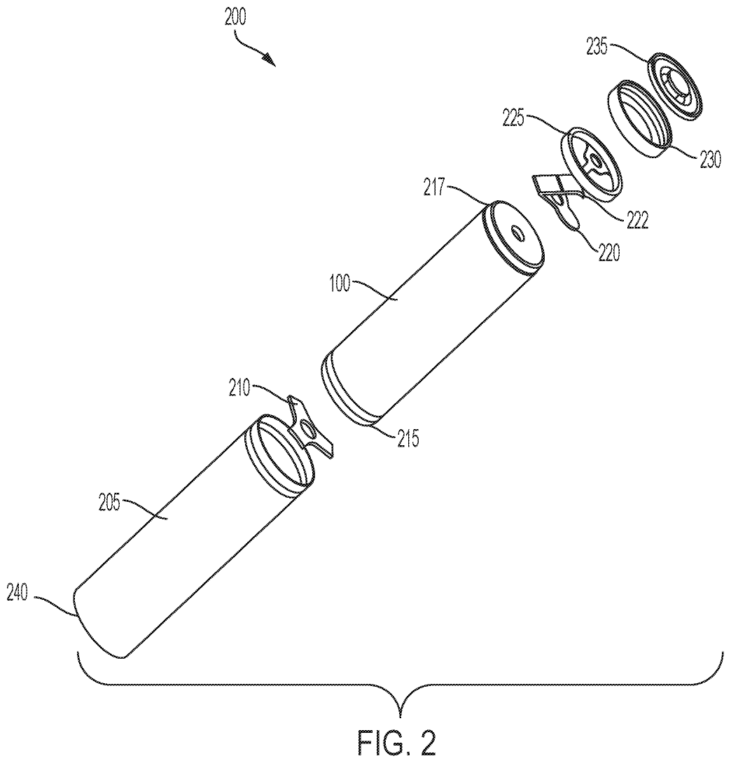

FIG. 1 illustrates an embodiment of a jelly roll 100 of a tables battery cell, such as battery cell 200 (FIG. 2). The jelly roll 100 is formed by rolling together an anode sheet, a cathode sheet, and an insulation sheet, as will be described in detail below. In some embodiments, an insulation sheet 105 may be provided on the exterior of the jelly roll 100. For example, the insulation sheet 105 may be formed of a separator film that is the same separator film used as an insulation sheet that is rolled with electrodes in the jelly roll 100. An uncoated portion 110 of an electrode (e.g., an anode and/or a cathode) is provided at a first end of the jelly roll 100. The uncoated portion 110 may be provided with at least one passageway 120 that provides an infiltration path for an electrolyte, as will be described in detail below. The uncoated portion 110 may undergo a rubbing process to form a rubbing region 115. In some embodiments, the rubbing process is performed on the uncoated portion 110 above the passageway 120. The rubbing process and rubbing region are described in more detail below. The rubbing region 115 allows the uncoated portion 110 of the jelly roll 100 to be coupled directly to a weld plate at the first end. The weld plate may then provide an electrical connection between electrode of the jelly roll 100 and battery terminals, such as terminal 235 (FIG. 2), as described in more detail below.

The jelly roll 100 may have a nominal voltage between approximately 1 V and approximately 5 V and a nominal capacity between about 1 Ah and about 5 Ah or more (e.g., up to about 9 Ah). The jelly roll 100 may have any rechargeable chemistry type, such as, for example Lithium (“Li”), Lithium-ion (“Li-ion”), other Lithium-based chemistry, Nickel-Cadmium (“NiCd”), Nickel-metal Hydride (“NiMH)”, etc.

FIG. 2 illustrates a battery cell 200 according to some embodiments. The battery cell 200 includes a battery cell case 205, a first weld plate 210, the jelly roll 100, a second weld plate 220, a first insulating member 225, a second insulating member 230, and a terminal 235. The battery cell 200 also includes a jelly roll such as jelly roll 100 (FIG. 1).

The battery cell case 205 is a casing that the jelly roll 100 is seated within along with the other battery cell 200 components described herein. In some embodiments, the battery cell case 205 may be referred to as a “can”. In some embodiments, the battery cell case 205 may be made of an insulative material. For example, the battery cell case 205 may be made of plastic or other non-conductive materials. Alternatively, in some embodiments, the battery cell case 205 may be made of a conductive material, such as steel, aluminum, or any other suitable metal. In some embodiments, the battery cell case 205 functions as a negative terminal to facilitate an external connection.

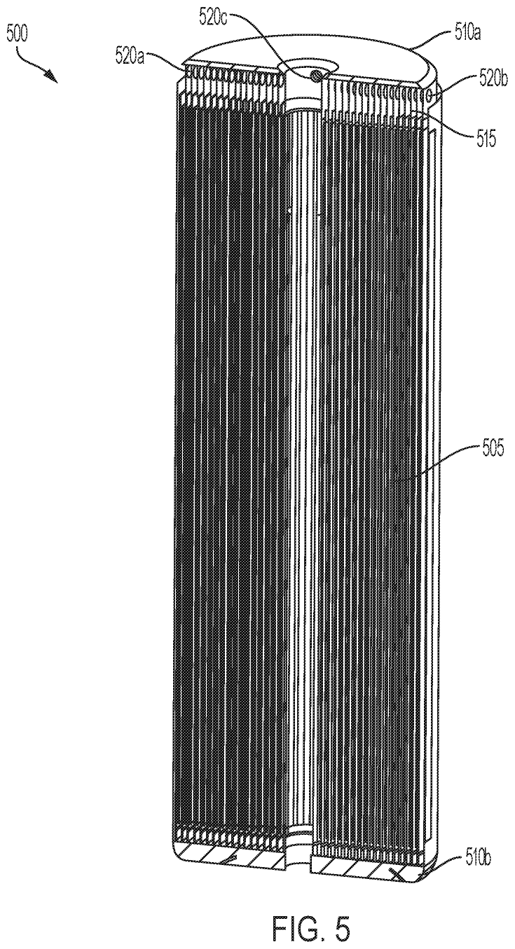

The first weld plate 210 may be affixed to a distal end 215 of the jelly roll 100. For example, the first weld plate 210 may be welded to a rubbing region, such as the second rubbing region 510b (FIG. 5), at the distal end 215 of the jelly roll 100 using one of laser welding, ultrasonic welding, or the like. In some embodiments, the first weld plate 210 may be comprised of a conductive material such as, but not limited to, nickel, copper, and/or the like. The second weld plate 220 may be affixed to a rubbing region, such as the first rubbing region 510a (FIG. 5), at a proximal end 217 of the jelly roll 100. Similar to the first weld plate 210, in some embodiments, the second weld plate 220 may be comprised of a conductive material such as, but not limited to, nickel, copper, and/or the like. In some embodiments, the second weld plate 220 may have a tab portion 222 extending radially inward and upward from an edge of the second weld plate 220. In some embodiments, the first insulating member 225 is made of plastic and/or rubber. The first insulating member 225 is provided with through holes such that the tab portion 222 will extend through the through hole and be welded to the terminal 235. The first insulating member 225 prevents contact between the first rubbing region of the jelly roll 100 and the battery cell case 205.

In some embodiments, the second insulating member 230 may be a gasket made of an insulating material. The second insulating member 230 may be sandwiched between the terminal 235 and the battery cell case 205 to prohibit electrical contact between the terminal 235 and the battery cell case 205.

The terminal 235 is an electrical contact that connects an electrode (e.g. anode or cathode) of the jelly roll 100 to an external device in order to provide electrical power to the external device. In some embodiments, the terminal 235 may receive power from an external device to recharge the jelly roll 100. In some embodiments, the terminal 235 is a positive electrode and is therefore electrically connected to the positive electrode sheet within the jelly roll 100. For example, the terminal 235 may connect the positive electrode sheet of the jelly roll 100 to a positive terminal of an external device that is to be powered by the battery cell 200. In some embodiments, the terminal 235 is made of metal. For example, the terminal 235 may be made of stainless steel.

A second terminal 240 is formed when the first weld plate 210 is connected to the bottom of the battery cell case 205, as the jelly roll 100 and the first weld plate 210 are seated in the battery cell case 205. In some embodiments, the second terminal 240 is a negative terminal.

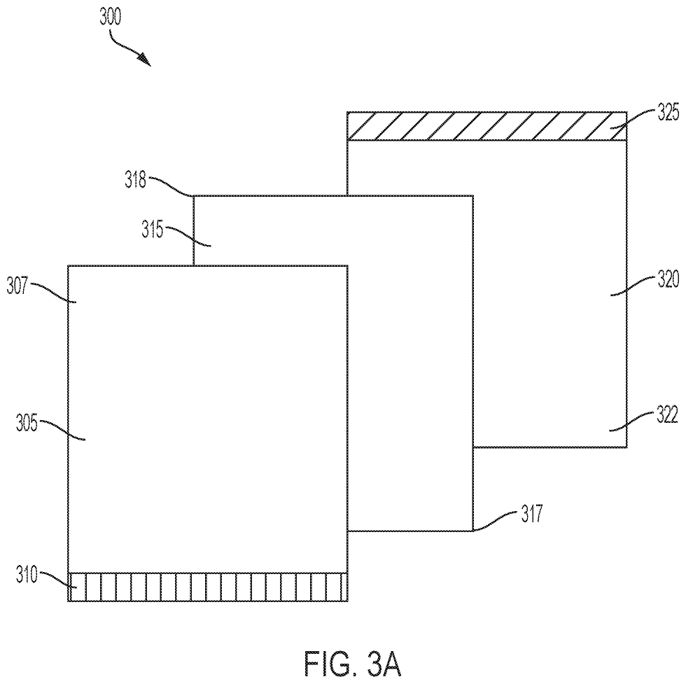

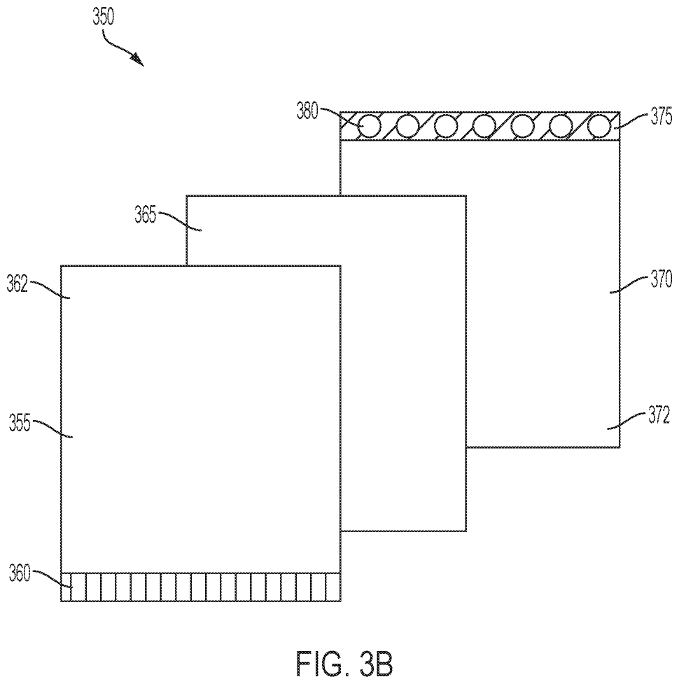

FIG. 3A illustrates example electrode sheets included in an example tables electrode assembly 300. Typically, tables electrode assemblies may not include a traditional battery tab that is attached to both the anode and the cathode, which connect the anode and the cathode to a battery terminal. Battery designs using tabbed configurations may have increased resistance due to the required tabs, resulting in reduced current capacity of the battery. Thus, tables electrode assemblies, such as tables electrode assembly 300, may have a reduced impedance between an output terminal and the anode and/or cathode, resulting in an increased current capacity over a tabbed battery configuration.

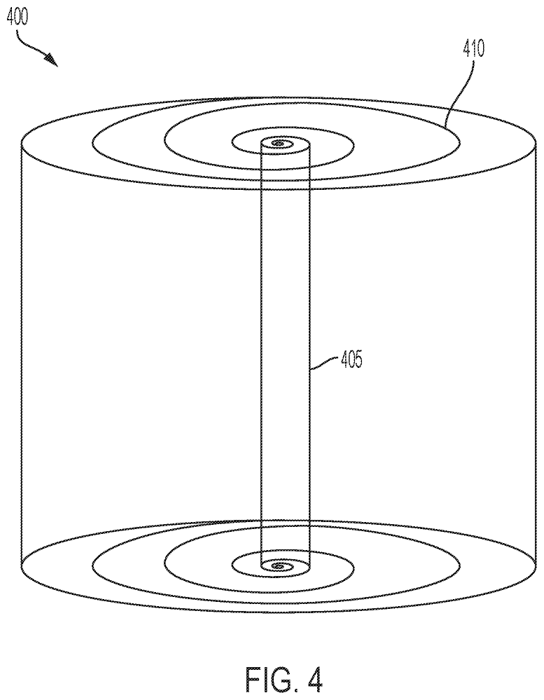

The electrode assembly 300 includes an anode sheet 305, a separator sheet 315, and a cathode sheet 320. In some embodiments, the anode sheet 305, the separator sheet 315, and the cathode sheet 320 are planar sheets that can be rolled to form a roll with concentric layers, such as rolled electrode assembly 400, shown in FIG. 4. While shown with only a single separator sheet 315, additional separator sheets may be used in a given battery application. For example, a second separator sheet may be used to provide separation between the cathode sheet 320 and the anode sheet 305 when the electrode assembly 300 is rolled. The anode sheet 305 includes a coated portion 307 and an uncoated portion 310. In some embodiments, the anode sheet 305 may be comprised of a base metal (e.g. copper (Cu)) with an anode material coated on a predetermined portion of the base metal to form the coated portion 307. The anode material forming the coated portion 307 may be comprised of graphite (C6), graphene (e.g., graphene encapsulated silicon (Si) nanoparticles), silicon, silicon dioxide, etc. The uncoated portion 310 may be continuously provided along a first edge of the anode sheet 305 with a height in the range of two to four millimeters (mm). The uncoated portion 310 may include a metallic or otherwise conductive surface to electrically coupled to a terminal, such as the terminal 235 or the second terminal 240, described above. For example, the uncoated portion 310 may have a metallic surface such as copper, aluminum, or other applicable metallic material.

In some embodiments, the anode sheet 305 is longer than the separator sheet 315. In particular, the uncoated portion 310 may extend past the length of the separator sheet 315 at a distal end 317 of the electrode assembly 300. For example, the uncoated portion 310 may extend in the range of one to four mm past the separator sheet 315 when the electrode assembly 300 is rolled. However, lengths of more than four mm or less than one mm are also contemplated. In some embodiments, the separator sheet 315 may be wider than the anode sheet 305. For example, the separator sheet 315 may extend in the range of one to four mm past the anode sheet 305 in a longitudinal direction.

The separator sheet 315 is interspersed between the anode sheet 305 and the cathode sheet 320. The separator sheet 315 is a medium that allows the passage of ions between the anode sheet 305 and the cathode sheet 320. For example, in a Lithium-ion battery cell, the separator sheet 315 allows lithium-ion atoms to pass through while blocking electrons from passing through. In some embodiments, the separator sheet 315 may have a thickness of 20 micrometers. However, thicknesses of more than 20 micrometers or less than 20 micrometers are also contemplated. In some embodiments, the separator sheet 315 may be made of polyethylene (PE), polypropylene (PP), or other material suitable for a given application.

The cathode sheet 320 includes a coated portion 322 and an uncoated portion 325. In some embodiments, the cathode sheet 320 may be comprised of a base metal (e.g., aluminum (Al)) with a cathode material coated on a predetermined portion of the base metal to form the coated portion 322. The cathode material forming the coated portion 322 may be comprised of lithium cobalt oxide (LiCoO2), lithium nickel manganese cobalt oxide (LiNixMnyCozO2 (x+y+z=1) or NMC), lithium nickel cobalt aluminum oxide (LiNixCoyAlzO2 (x+y+z=1)), a polyanion (e.g., such as lithium iron phosphate (LiFePO4)), a spinel (such as lithium manganese oxide (LiMn2O4, Li2MnO, or LMO)), etc. The uncoated portion 325 may be continuously provided along a second edge, opposite the first edge, of the cathode sheet 320 with a height in the range of five to seven mm. The uncoated portion 325 may include a metallic or otherwise conductive surface to electrically coupled to a terminal, such as the terminal 235 or the second terminal 240, described above. For example, the uncoated portion 325 may have a metallic surface such as copper, aluminum, or other applicable metallic material.

In some embodiments, the cathode sheet 320 is longer than the separator sheet 315 and/or the anode sheet 305. In particular, the uncoated portion 325 extends past the length of the separator sheet 315 at a proximal end 318 of the electrode assembly 300. For example, the uncoated portion 325 extends in the range of three to seven mm past the separator sheet 315 when the electrode assembly 300 is rolled. However, lengths of more than four mm or less than one mm are also contemplated. A rubbing process may be performed on the uncoated portion 325. For example, each concentric layer of the uncoated portion 325 may be rubbed together to form a flat surface that couples to a weld place, such as second weld plate 220 (FIG. 2). When rubbed, the uncoated portion 325 extends between one to two mm past the separator sheet 315.

FIG. 3B illustrates electrode sheets included in an enhanced electrode assembly 350 for enhancing electrolyte infiltration within a jelly roll, such as jelly roll 100. Similar to the electrode assembly 300 of FIG. 3A, the electrode assembly 350 includes an anode sheet 355, a separator sheet 365, and a cathode sheet 370. While shown with only a single separator sheet 365, additional separator sheets may be used in a given battery application. For example, a second separator sheet may be used to provide separation between the anode sheet 355 and the cathode sheet 370 when the electrode assembly 350 is rolled. In some embodiments, the anode sheet 355, the separator sheet 365, and the cathode sheet 370 are planar sheets that can be rolled to form a roll with concentric layers, as will be described in more details below. The anode sheet 355 includes a coated portion 362 and an uncoated portion 360. The anode sheet 355 and the coated portion 362 are comprised of similar materials as the anode sheet 305 and the coated portion 307 (FIG. 3A), respectively. The uncoated portion 360 may be continuously provided along a first longitudinal end of the anode sheet 355 with a height in the range of two to four mm. Similar to the uncoated portion 310, the uncoated portion 360 may include a metallic or otherwise conductive surface to electrically coupled to a terminal, such as the terminal 235 or the second terminal 240, described above. For example, the uncoated portion 360 may have a metallic surface such as copper, aluminum, or other applicable metallic material.

The separator sheet 365 is a porous medium interspersed between the anode sheet 355 and the cathode sheet 370 to allow the passage of ions between the anode sheet 355 and the cathode sheet 370. The separator sheet 365 may be substantially the same as the separator sheet 315 (FIG. 3A).

The cathode sheet 370 includes a coated portion 372 and an uncoated portion 375. In one embodiment, the cathode sheet 370 and the coated portion 372 are comprised of similar materials as the cathode sheet 320 and the coated portion 322 (FIG. 3A), respectively. The uncoated portion 375 may be continuously provided along a second longitudinal end, opposite the first longitudinal end, of the cathode sheet 370 with a height in the range of five to seven mm. The uncoated portion 375 may include a metallic or otherwise conductive surface to electrically coupled to a terminal, such as the terminal 235 or the second terminal 240, described above. For example, the uncoated portion 375 may have a metallic surface such as copper, aluminum, or other applicable metallic material.

In one embodiment, one or more apertures 380 are formed in the uncoated portion 375 of the cathode sheet 370. In some embodiments, the apertures 380 are through holes and/or slits (e.g. elongated openings) that are formed in the uncoated portion 375 prior to the electrode assembly 350 being rolled together to form the jelly roll 100. The apertures 380 are configured to receive an electrolyte that will flow through the apertures 380 and infiltrate the concentric layers (e.g., the electrode assembly 350, once rolled) of the jelly roll 100. In some embodiments, the apertures 380 are equally spaced from one another along an axis and formed along the entire length of the uncoated portion 375. In further embodiments, the apertures 380 are spaced from one another such that when the electrode assembly 350 is rolled together, the apertures 380 line up with one another through each concentric layer such that one or more passageways are formed from an outer layer of the electrode assembly 350 to a center of the electrode assembly 350, as shown in more detail below. For example, the apertures 380 may be configured to provide four passageways from an outer layer of the electrode assembly 350 to a center portion of the electrode assembly 350. In some embodiments, the apertures 380 are formed such that the four passageways are a predetermined angular distance from one another when the electrode assembly 350 is rolled. For example, the apertures 380 may line up such that the passageways are 90° from one another along the exterior of the rolled electrode assembly. In other examples, more than four passageways or less than four passageways may also be formed. Alternatively, in some embodiments, the apertures 380 are formed after a rubbing process takes place, as will be described below. As will be discussed in detail below, the apertures 380 allow for an electrolyte to infiltrate between the concentric layers of the jelly roll 100 that is made of the electrode assembly 350.

A rolled electrode assembly 400, according to some embodiments, is illustrated in FIG. 4. The rolled electrode assembly 400 includes an electrode assembly, such as electrode assembly 350 (FIG. 3B), that has been rolled to form a center 405 with concentric layers 410 wound around the center 405. In some embodiments, the rolled electrode assembly 400 is wound around a center pin. The concentric layers 410 extend radially outward from the center 405 of the rolled electrode assembly 400. The concentric layers 410 may be pressed together, leaving little space between each concentric layer. However, an electrolyte is provided via the apertures 380, which allows the electrolyte to infiltrate into the concentric layers of the rolled electrode assembly 400. For example, the electrolyte may disperse across a top of the electrode assembly via apertures 380 and soak into the anode electrode and the cathode electrode, such as the anode sheet 355 and the cathode sheet 370 described above. In some embodiments, soaking the anode sheet 355 and the cathode sheet 370 includes filling pores of the anode sheet 355 and the cathode sheet 370 with the electrolyte. Additionally, in some embodiments, soaking includes applying a pressure to the battery cell 200 to activate a capillary effect. By allowing the electrolyte to flow through the apertures, the electrolyte may be more evenly distributed across the top of the electrode assembly 300, 350, thereby ensuring more efficient dispersion of the electrolyte within the rolled electrode assembly, as described in more detail below.

FIG. 5 illustrates a cross-sectional view of a jelly roll 500, according to some embodiments. The jelly roll 500 may be substantially the same as jelly roll 100 (FIG. 1). The jelly roll 500 includes a rolled electrode assembly 505, a first rubbing region 510a, a second rubbing region 510b, an uncoated portion 515, and passageways 520a, 520b, 520c. The passageways 520a, 520b, 520c may be formed by apertures, such as the apertures 380 (FIG. 3B). The rolled electrode assembly 505 may be substantially the same as rolled electrode assembly 400 (FIG. 4). As described above, an electrolyte (not shown) is generally introduced into the concentric layers of the electrode assembly 505. The electrolyte facilitates movement of the lithium-ions between the anode sheet and the cathode sheet. In some embodiments, the electrolyte is made of a liquid with at least one of dissolved salts, acids, and alkalis.

The first rubbing region 510a is provided at a proximal end of the jelly roll 500. In some embodiments, the first rubbing region 510a is comprised of concentric layers of the uncoated portion 515 that are rubbed together to create a flat surface. In one example, the flat surface is orthogonal to the rolled electrode assembly 505. For example, the uncoated portion 515 may be between one and four mm tall prior to the first rubbing region 510a being formed during a rubbing process. After the rubbing process, the uncoated portion 515 may extend between one and two mm past the rolled sheets of the rolled electrode assembly 505. The first rubbing region 510a connects the electrode assembly 505 to a weld plate, such as second weld plate 220 (FIG. 2). In some embodiments, the first rubbing region 510a is laser welded to the weld plate.

The second rubbing region 510b is provided at a distal end of the jelly roll 500. In some embodiments, the second rubbing region 510b is comprised of an uncoated portion of an anode sheet, such as uncoated portion 310, 360 (FIGS. 3A and 3B, respectively). For example, concentric layers of the uncoated portion of the anode sheet may be rubbed together in the rubbing process in order to create a flat surface.

Typically, the electrolyte may be injected at the top of the rolled electrode assembly 505 using a nozzle. For example, after the jelly roll 500 is inserted in a battery cell case, such as battery cell case 205 (FIG. 2), and welded to the terminals, such as terminal 235 (FIG. 2), the electrolyte may be introduced into the battery cell case 205 and infiltrate the jelly roll 500. The electrolyte may flow through a hole in the center of the first rubbing region 510a to infiltrate the concentric layers of the jelly roll 500.

Passageways 520a, 520b, 520c may be provided between the first rubbing region 510a and the coated portion of the jelly roll, such that the passageways 520a, 520b, 520c are provided on the uncoated portion 515 to allow for the electrolyte to effectively and efficiently infiltrate between the concentric layers of the electrode assembly 505. In some embodiments, the passageways 520a, 520b, 520c are formed after the first rubbing region 510a has been formed using a rubbing process. The passageways 520a, 520b, 520c may be formed by drilling holes in the uncoated portion 515 along a diameter of the jelly roll 500 starting at a first side of the uncoated portion 515 and going through to the opposite side of the uncoated portion 515. Alternatively, or additionally, the passageways 520a, 520b, 520c may be formed using a laser. In some embodiments, passageways 520a, 520b, 520c are formed along diameters of the jelly roll 500 such that each concentric layer along a diameter has an aperture that lines up with each of the passageways 520a, 520b, 520c. Alternatively, or additionally, in some embodiments, each concentric layer has an aperture that does not line up with the aperture of the adjacent concentric layer. In this embodiment, passageways are formed due to space between the concentric layers of the uncoated portion 515 that connects the apertures together to form passageways. The space between the concentric layers of the uncoated portion 515 is a result of the uncoated portion 515 extending above the coated portion of anode sheet, the coated portion of the cathode sheet, and the separator, as described above.

Alternatively, or additionally, passageways (not shown) may be formed in a longitudinal direction (parallel to a longitudinal direction of the cell) such that they would be formed through the top, flattened surface of the first rubbing region 510a. In some embodiments, the jelly roll 500 includes a fourth passageway parallel to the passageway 520c. The passageways 520a, 520b, 520c provided at the proximal end of the jelly roll 500 as illustrated in FIG. 5, are merely exemplary. In some embodiments, passageways may be formed of apertures that are provided at the distal end of the jelly roll 500, adjacent the second rubbing region 510b. Alternatively, or additionally, passageways may be formed of apertures that are provided at both the proximal and the distal ends of the jelly roll 500. Providing apertures that form passageways at both ends of the jelly roll 500 may further reduce an electrolyte infiltration time and improve electrolyte dispersion within the jelly roll 500.

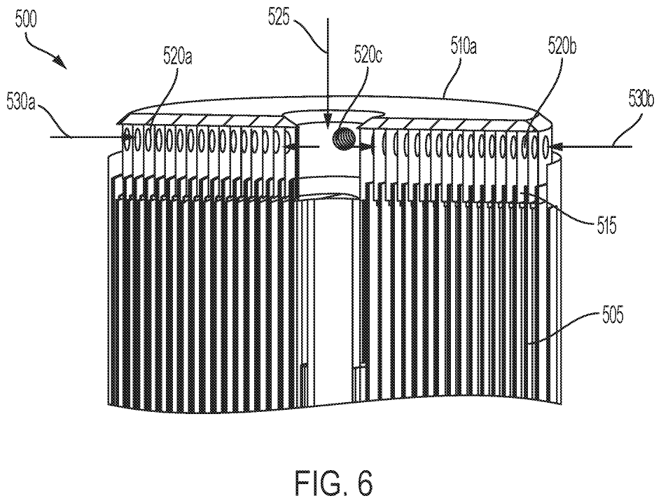

FIG. 6 illustrates a magnified cross-sectional view of the jelly roll 500 shown in FIG. 5. Arrows illustrate electrolyte infiltration paths, 525, 530a, 530b. In some embodiments, the electrolyte is injected into the passageways 520a, 520b, 520c after the jelly roll 500 is seated into a battery cell case, such as battery cell case 205 (FIG. 2), and after the electrolyte is introduced into the battery cell case. For example, the electrolyte may be injected into the battery cell case using a targeted nozzle. The electrolyte will then flow into each passageway 520a, 520b, 520c. In some embodiments, the electrolyte flows radially towards the center of the electrode assembly 505 and longitudinally through the concentric layers of the electrode assembly 505, soaking the anode sheet and the cathode sheet. As another example, the electrolyte may be introduced along an outer edge and/or through the center of the jelly roll 500 and the electrolyte may then flow through the concentric layers of the electrode assembly 505 via the passageways 520a, 520b, 520c. The electrolyte may infiltrate into available space within the jelly roll 500 due to gravity and/or the capillary effect. The passageways 520a, 520b, 520c reduce the infiltration time of the electrolyte by allowing the electrolyte to flow radially along the proximal end of the electrode assembly 505. In some embodiments, the electrolyte may be injected under high pressure which may further reduce the infiltration time.

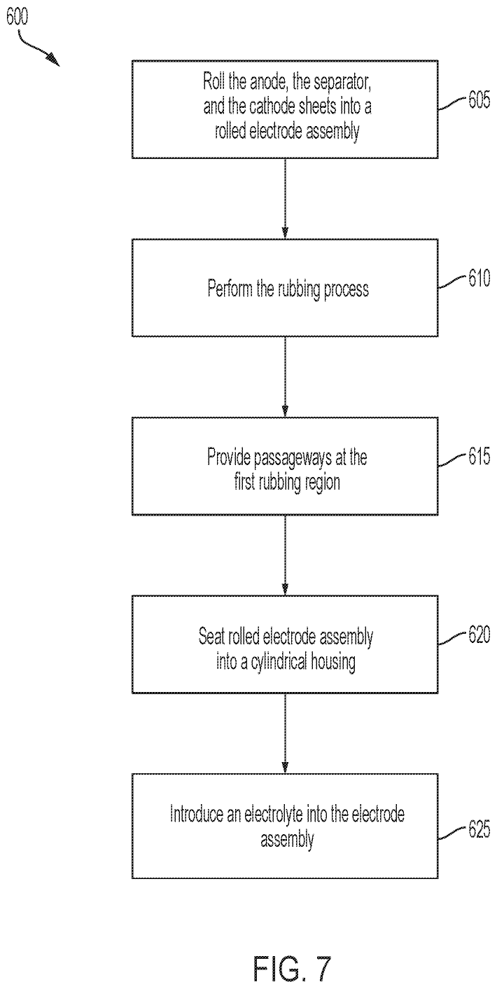

FIG. 7 is a flow chart illustrating a process 600 for fabricating a battery cell, such as rolled electrode assembly 505, according to some embodiments. While the process 600 is performed using components described in regards to FIGS. 3-6, above, it is understood that other components may be used to create the battery cell described in process 600.

At process block 605, the anode sheet 305, the separator sheet 315, and the cathode sheet 320 are rolled into a rolled electrode assembly, as described above. For example, the anode sheet 305, the separator sheet 315, and the cathode sheet 320 are rolled to form a rolled electrode assembly, such as rolled electrode assembly 505, such that the anode sheet 305, the separator sheet 315, and the cathode sheet 320 form concentric layers. The uncoated portions of the anode sheet 305 and the cathode sheet 320 may have gaps between each concentric layer due to the absence of the coating materials that is present on the coated portions of the anode sheet and the cathode sheet.

At process block 610, a rubbing process is performed. The rubbing process is performed on the uncoated portion 310 of the anode sheet 305 and/or the uncoated portion 325 of the cathode sheet 320 to create at least one rubbing region, such as first rubbing region 510a and/or second rubbing region 510b. In some embodiments, the rubbing process may include trimming the uncoated portion 310 to a desired height, such as uncoated portions 310, 325 (FIG. 3A), compressing together a plurality of adjacent concentric layers of the uncoated portions 310, 325 of the rolled electrode assembly 505, folding and/or rolling over a plurality of adjacent concentric layers of the uncoated portions 310, 325 of the rolled electrode assembly 505, or rubbing together a plurality of adjacent concentric layers of the uncoated portions 310, 325 of the rolled electrode assembly 505 to form a compressed uniform surface. For example, the concentric layers of the rolled electrode assembly 505 that are formed of the uncoated portion 325 of the cathode sheet 320 may be compressed together and folded over by a smoothing process to create a flat rubbing region, such as the first rubbing region 510a (FIG. 5). The top of the concentric layers of the uncoated portion 325 may be secured to one another to provide the flat, uniform rubbing region.

At process block 615, one or more passageways, such as passageways 520a, 520b, 520c (FIG. 5), are formed on an uncoated portion of the anode sheet 305 and/or the cathode sheet 320. In some embodiments, passageways 520a, 520b, 520c are formed radially outwards from the center of the electrode assembly 505 such that each concentric layer has an aperture that lines up with the other apertures of the adjacent concentric layers to form passageways 520a, 520b, 520c. Alternatively, or additionally, apertures are formed in a longitudinal direction such that they would be formed through a top, flattened surface of the first rubbing region 510a. In some embodiments, passageways 520a, 520b, 520c are formed by drilling holes through each concentric layer of the electrode assembly. Alternatively, in some embodiments, passageways 520a, 520b, 520c are formed using a laser.

At process block 620, the rolled electrode assembly 505 is seated into a cylindrical housing, such as the battery cell case 205 described above. In some embodiments, an adhesive may be applied between an outer surface of the rolled electrode assembly 505 and an inner surface of the battery cell case 205. For example, expansion tape, glue, and/or sticky tape may secure the rolled electrode assembly from movement within the battery cell case 205.

At process block 625, an electrolyte is introduced into the electrode assembly 505. In some embodiments, the electrolyte is introduced radially through the passageways 520a, 520b, 520c and/or longitudinally through the center of the electrode assembly 505. Alternatively, or additionally, in some embodiments, the electrolyte may be introduced along an outer edge and/or through the center of the electrode assembly. The electrolyte infiltrates the concentric layers of the electrode assembly 505, soaking the anode sheet 305 and the cathode sheet 320.

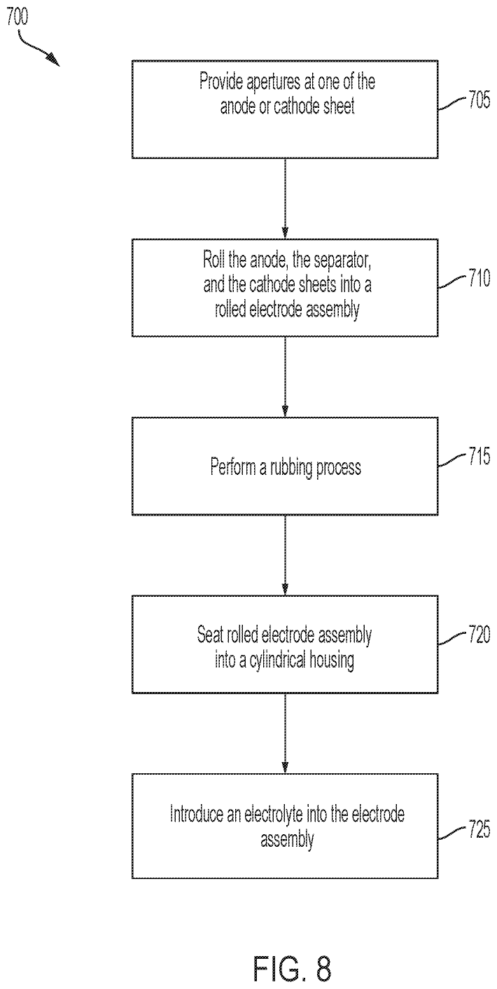

FIG. 8 is a flow chart illustrating a process 700 for fabricating a battery cell, such as rolled electrode assembly 505, according to some embodiments. While the process 700 is performed using components described in regards to FIGS. 3-6, above, it is understood that other components may be used to create the battery cell described in process 700.

At process block 705, apertures 380 are provided at the uncoated portion 325 of the cathode sheet 320. The apertures 380 are provided at locations on the uncoated portion 325 such that when the cathode sheet 320 is rolled with the anode sheet 305 and the separator sheet 315, the apertures 380 line up with one another to form passageways, such as passageways 520a, 520b, 520c (FIG. 5). In some embodiments, after the rolling process, the apertures 380 may not line up with one another, creating passageways 520a, 520b, 520c that are not linear or substantially aligned. Rather, the apertures 380 may be formed such that each concentric layer of the rolled electrode assembly is randomly provided with at least one aperture. At process block 710, the anode sheet 305, the separator sheet 315, and the cathode sheet 320 are rolled together into a rolled electrode assembly. For example, the anode sheet 305, the separator sheet 315, and the cathode sheet 320 are rolled to form the rolled electrode assembly 505 with concentric layers. The uncoated portions of the anode sheet 305 and the cathode sheet 315 may have gaps between each concentric layer due to the absence of the coating materials that is present on the coated portions of the anode sheet and the cathode sheet. However, as uncoated portions of the anode sheet 305 and the cathode sheet 320 may have gaps between each concentric layer due to the absence of the coating materials that is present on the coated portions of the anode sheet and the cathode sheet (see above), the electrolyte may still flow between the concentric layers of the uncoated portions via the apertures 380.

At process block 715, a rubbing process is performed. The rubbing process is performed on the uncoated portion 310 of the anode sheet 305 and/or the uncoated portion 325 of the cathode sheet 320 to create at least one rubbing region, such as first rubbing region 510a and/or second rubbing region 510b. The rubbing process may be similar to the rubbing process described above with respect to process block 615 (FIG. 6).

At process block 720, the rolled electrode assembly 505 is seated into a cylindrical housing, such as the battery cell case 205 described above. In some embodiments, an adhesive may be applied between an outer surface of the rolled electrode assembly 505 and an inner surface of the battery cell case 205. For example, expansion tape, glue, or sticky tape may secure the rolled electrode assembly from movement within the battery cell case 205.

At process block 725, an electrolyte is introduced into the electrode assembly 505. In some embodiments, the electrolyte is introduced radially through the passageways 520a, 520b, 520c and/or longitudinally through the center of the electrode assembly 505. Alternatively, or additionally, in some embodiments, the electrolyte may be introduced along an outer edge and/or through the center of the electrode assembly 505. The electrolyte infiltrates the concentric layers of the electrode assembly 505, soaking the anode sheet 305 and the cathode sheet 320, as described above.

Thus, embodiments described herein provide, among other things, electrolyte infiltration in a battery cell. Various features and advantages are set forth in the following claims.

What is claimed is:

1. A cylindrical battery cell comprising:
an anode;
a cathode;
one or more separator sheets that separates the anode from the cathode;
an electrolyte; and
a cylindrical housing;
wherein the anode, the one or more separator sheets, and the cathode are rolled together to form a roll, wherein the anode, the cathode and the one or more separator sheets form concentric layers within the roll;
wherein the roll is seated in the cylindrical housing; and
wherein at least one selected from a group consisting of the anode and the cathode includes a plurality of apertures positioned from an inner radial surface of the roll to an outer radial surface of the roll, the plurality of apertures forming one or more passageways that are configured to facilitate a flow of the electrolyte within the roll.

2. The cylindrical battery cell of claim 1, wherein the plurality of apertures are formed on an uncoated portion of at least one selected from the group consisting of the anode and the cathode.

3. The cylindrical battery cell of claim 2, wherein the uncoated portion of at least one selected from the group consisting of the anode and the cathode is rubbed to create a rubbing region with a flat top surface.

4. The cylindrical battery cell of claim 2, wherein the uncoated portion extends past the one or more separator sheets in the roll.

5. The cylindrical battery cell of claim 2, wherein the roll includes gaps between the concentric layers of the uncoated portion of the roll, the gaps forming a portion of the passageways.

6. The cylindrical battery cell of claim 5, wherein the electrolyte flows in a downward direction into the roll.

7. The cylindrical battery cell of claim 1, wherein the one or more passageways are at a predetermined angular distance from one another.

8. The cylindrical battery cell of claim 1, wherein the electrolyte is introduced at least one selected from a group consisting of radially through the one or more passageways and longitudinally through a center of the roll.

9. The cylindrical battery cell of claim 1, wherein the plurality of apertures are formed by at least one selected from a group consisting of drilling a circular hole through the concentric layers of the roll or lasering the circular hole through the concentric layers of the roll.

10. A method of infiltrating an electrolyte in a cylindrical battery cell, the method comprising:
rolling an anode, one or more separator sheets, and a cathode about a central axis to form a roll with concentric layers;
rubbing a portion of at least one selected from a group consisting of the anode and the cathode to create a rubbing region with a flat top surface;
forming a plurality of apertures at the rubbing region of at least one selected from the group consisting of the anode and the cathode, the plurality of apertures being formed radially from a center of the roll to an outer surface of the roll to form one or more passageways;
inserting the roll in a cylindrical battery housing; and
introducing an electrolyte at least one of radially into at least one of the one or more passageways and longitudinally through the center of the roll.

11. The method of claim 10, wherein the portion of at least one selected from the group consisting of the anode and the cathode that is rubbed is an uncoated portion.

12. The method of claim 11, wherein the plurality of apertures are formed on the uncoated portion.

13. The method of claim 10, wherein the one or more passageways are at a predetermined angular distance from one another.

14. The method of claim 10, wherein the roll includes one or more gaps between the concentric layers of the uncoated portion of the roll.

15. The method of claim 14, wherein the electrolyte flows in a downward direction into the roll.

16. A tables battery cell comprising:
an anode;
a cathode;
one or more separator sheets that separates the anode from the cathode; and
an electrolyte;
wherein the anode, the one or more separator sheets, and the cathode are rolled together to form a roll and form concentric layers within the roll;
wherein a portion of at least one selected from a group consisting of the anode and the cathode is rubbed together to create an rubbing region with a flat top surface; and
wherein at least one selected from the group consisting of the anode and the cathode includes a plurality of apertures forming one or more passageways configured to allow the electrolyte to flow downwards into the roll, the one or more passageways configured to be filled with the electrolyte.

17. The tables battery cell of claim 16, wherein the plurality of apertures are formed on an uncoated portion of at least one selected from the group of the anode and the cathode.

18. The tables battery cell of claim 17, where the plurality of apertures are formed at least one selected from a group consisting of radially through the concentric layers of the uncoated portions or longitudinally through a flat, top surface of the rubbing region.

19. The tables battery cell of claim 17, wherein the roll includes gaps between the concentric layers of the uncoated portion of the at least one selected from the group consisting of the anode and the cathode.

20. The tables battery cell of claim 19, wherein the electrolyte flows into the gaps and downward into the roll soaking the anode and the cathode.
